(19) United States
(12) Patent Application Publication
(10) Pub. No.: US 2024/0275105 A1
(43) Pub. Date: Aug. 15, 2024

(54) CONNECTOR AND RETAINER

(71) Applicants: FURUKAWA ELECTRIC CO., LTD., Tokyo (JP); FURUKAWA AUTOMOTIVE SYSTEMS INC., Inukami-gun (JP)

(72) Inventors: Takayuki HIGUCHI, Inukami-gun (JP); Takeshi WATANABE, Inukami-gun (JP); Tomoaki TANIGAWA, Inukami-gun (JP); Sota KAMON, Inukami-gun (JP); Takuto WADA, Inukami-gun (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 18/644,206

(22) Filed: Apr. 24, 2024

Related U.S. Application Data
(63) Continuation of application No. PCT/JP2022/039453, filed on Oct. 24, 2022.

(30) Foreign Application Priority Data
Oct. 25, 2021 (JP) 2021-174123

(51) Int. Cl. H01R 13/58; H01R 13/52

(52) U.S. Cl. CPC H01R 13/5816; H01R 13/5208; H01R 2201/26

(57) ABSTRACT

A harness-side connector includes a retaining portion main body having a harness-side terminal disposed therein, a shell main body, a harness insertion cylinder and a harness insertion outer cylinder. A retainer outserted over a portion, of a high-voltage electric wire that is inserted into the harness insertion cylinder and the harness insertion outer cylinder, to be secured is provided. The retainer includes a retainer securing portion inserted into the harness insertion outer cylinder to be secured, and an electric wire retaining portion protruding from the harness insertion outer cylinder and retaining the high-voltage electric wire. The electric wire retaining portion includes a securing-side retaining portion integrally formed with the retainer securing portion, and an attachment retaining portion attached to the securing-side retaining portion.

### BACKGROUND OF INVENTION

### Field of Invention

The present disclosure relates to a connector to be attached to, for example, a wire harness or the like and to e connected to a device such as a motor or the like, and also relates to a retainer retaining an electric wire to the connector.

### Background Art

An electric device mounted on an automobile or the like is connected with another electric device or a power supply device via a wire harness including a bundle of covered electric wires and thus forms an electric circuit. The wire harness and the electric device or the power supply device are connected with each other via connectors attached thereto.

For example, a harness-side connector described in Japanese Laid-Open Patent Publication No. 2012-109035 (Patent Literature 1) is connected with a device-side connector included in a device such as a motor or the like.

Specifically, a terminal provided in the harness-side connector and a terminal provided in the device-side connector are connected with each other to connect the harness-side connector and the device-side connector to each other in an electrically conductive manner.

In the case where the voltage for the electric conduction in such a connector connection structure is increased and as a result, an electric wire having a large diameter is used, such an electric wire to be inserted into a connector housing needs to be more rigid. When such a rigid electric wire is vibrated, the vibration may undesirably affect the connector.

### CITATION LIST

### Patent Literature

Patent Literature 1: JP 2012-109035 A

### SUMMARY

### Technical Problem

The present disclosure has an object of providing a connector and a retainer that even if an electric wire is vibrated, suppress influence of the vibration on the connector.

### Solution to Problem

The present disclosure is directed to a connector including an electric wire having a harness-side terminal attached to a tip thereof; and a housing having the harness-side terminal disposed therein. The housing includes a main body having the harness-side terminal disposed therein, and an electric wire insertion portion in communication with the main body, the electric wire insertion portion having the electric wire inserted thereinto. The connector further includes a retainer outserted over a portion of the electric wire that is inserted into the electric wire insertion portion and thus retaining the electric wire. The retainer includes a retainer securing portion inserted into the electric wire insertion portion to be secured, and an electric wire retaining portion protruding from the electric wire insertion portion and retaining the electric wire. The electric wire retaining portion has an electric wire insertion hole retaining the electric wire inserted therethrough, and includes a securing-side retaining portion integrally formed with the retainer securing portion, the securing-side retaining portion defining a part of the electric wire insertion hole, and an attachment retaining portion defining another part of the electric wire insertion hole, the attachment retaining portion being attached to the securing-side retaining portion.

The present disclosure is also directed to a retainer included in a connector including an electric wire having a harness-side terminal attached to a tip thereof, and a housing having the harness-side terminal disposed therein, the housing including a main body having the harness-side terminal disposed therein and an electric wire insertion portion in communication with the main body, the electric wire insertion portion having the electric wire inserted thereinto. The retainer includes a retainer securing portion inserted into the electric wire insertion portion to be secured, and an electric wire retaining portion protruding from the electric wire insertion portion and retaining the electric wire. The electric wire retaining portion has an electric wire insertion hole retaining the electric wire inserted therethrough, and includes a securing-side retaining portion integrally formed with the retainer securing portion, the securing-side retaining portion defining a part of the electric wire insertion hole, and an attachment retaining portion defining another part of the electric wire insertion hole, the attachment retaining portion being attached to the securing-side retaining portion. The retainer is outserted over, and secures, the electric wire inserted into the electric wire insertion portion.

With this disclosure, even if a vibration acts on the electric wire, exertion of the influence of the vibration on the connector may be suppressed.

This will be described in more detail. The housing includes the main body having the harness-side terminal disposed therein, and the electric wire insertion portion in communication with the main body, the electric wire insertion portion having the electric wire inserted thereinto. The retainer, which is outserted over, and secures, the electric wire inserted into the electric wire insertion portion of the housing, includes the retainer securing portion inserted into the electric wire insertion portion to be secured, and the electric wire retaining portion protruding from the electric wire insertion portion and retaining the electric wire. The electric wire retaining portion inserted into the electric wire insertion portion includes the securing-side retaining portion integrally formed with the retainer securing portion, the securing-side retaining portion defining a part of the electric wire insertion hole, and also includes the attachment retaining portion defining another part of the electric wire insertion hole, the attachment retaining portion being attached to the securing-side retaining portion.

Therefore, in a state where the retainer is secured to the electric wire insertion portion by the retainer securing portion, the attachment retaining portion is attached to the securing-side retaining portion integrally formed with the retainer securing portion. With such a configuration, the electric wire insertion hole is formed, and thus the electric wire may be secured. That is, the electric wire is secured to the housing via the retainer. Even if a vibration acts on the electric wire, the exertion of the influence of the vibration on the housing may be suppressed.

The electric wire retaining portion, which secures the electric wire by attaching the attachment retaining portion to the securing-side attachment portion integrally formed with the retainer securing portion, protrudes from the electric wire insertion portion. Therefore, the attachment retaining portion may be attached to the securing-side attachment portion easily.

After the relative positions of the housing, the electric wire and the retainer are adjusted, the attachment retaining portion is attached to the securing-side retaining portion, protruding from the electric wire insertion portion, to retain the electric wire. With such a configuration, the electric wire may be secured to the housing easily and with high precision.

The securing-side retaining portion and the attachment retaining portion may be formed separately from each other. Alternatively, for example, the attachment retaining portion may be pivotably coupled with the securing-side retaining portion, so that the securing-side retaining portion and the attachment retaining portion are integrally formed together.

In an embodiment of the disclosure, the connector may further include a pressing portion provided on an inner surface defining the electric wire insertion hole, the pressing portion locally pressing an outer surface of the electric wire.

The “inner surface defining the electric wire insertion hole” refers to at least one of an inner surface defining a part of the electric wire insertion hole in the securing-side retaining portion and an inner surface defining another part of the electric wire insertion hole in the attachment retaining portion.

With this disclosure, the attachment retaining portion is attached to the securing-side retaining portion, so that the pressing portion locally presses the outer surface of the electric wire inserted through the electric wire insertion hole. Therefore, the securing force of the electric wire retaining hole of the retainer on the electric wire is increased, and thus the electric wire may be retained with certainty.

The pressing portion may have any shape that allows the local pressure imposed on the outer surface of the electric wire to be increased. The pressing portion may be, for example, a protrusion or a convexed and concaved portion formed on the inner surface of the electric wire insertion portion.

In another embodiment of the disclosure, the attachment retaining portion and the securing-side retaining portion may be formed separately from each other. The connector may include an engaging portion putting the attachment retaining portion and the securing-side retaining portion, which are formed separately from each other, into engagement with each other to assemble and secure the attachment retaining portion and the securing-side retaining portion to each other.

With this disclosure, the electric wire may be disposed in the electric wire insertion hole provided in the securing-side retaining portion formed separately from the attachment retaining portion. The attachment retaining portion is attached to the securing-side retaining portion having the electric wire disposed therein, and is put into engagement with the securing-side retaining portion by the engaging portion. With such a configuration, the electric wire inserted through the electric wire insertion hole may be retained easily and with certainty.

In an embodiment of the disclosure, the connector may further include an electric wire seal outserted over the portion of the electric wire that is inserted into the electric wire insertion portion, the electric wire seal sealing a space between the electric wire insertion portion and the electric wire at a position closer to the tip of the electric wire than the retainer.

With this disclosure, the space between the electric wire insertion portion and the electric wire may be sealed at a position on the top side with respect to the retainer. In addition, the electric wire seal is disposed on the tip side with respect to the retainer, and therefore, the electric wire seal may be prevented by the retainer from being pulled off inadvertently.

The retainer securing portion, of the retainer, disposed in the electric wire insertion portion may press the electric wire seal to cause a pre-stress to act on the electric wire seal, so as to improve the sealing capability of the electric wire seal. Alternatively, the electric wire seal and the retainer securing portion may be put into contact with each other, or the electric wire seal and the retainer securing portion may be disposed with a space therebetween, so that the electric wire seal is prevented from being pulled off inadvertently.

In an embodiment of the disclosure, a plurality of the electric wires may be provided, and a plurality of the electric wire insertion portions may be provided in correspondence with the number of the electric wires.

With this disclosure, the plurality of electric wires may be inserted into the electric wire insertion holes respectively, and may be secured with certainty. The electric wire insertion holes provided in accordance with the number of the electric wires may be coupled with each other.

In an embodiment of the disclosure, the connector may further include a retainer engaging portion engaged with, and securing, the retainer securing portion inserted into the electric wire insertion portion.

With this disclosure, the retainer engaging portion may be put into engagement with the electric wire insertion portion to secure the retainer securing portion. Therefore, the retainer securing portion may be inserted into the electric wire insertion portion to engage and secure the retainer securing portion to the retainer engaging portion. The ease of assembly may be improved over the case where, for example, the retainer securing portion is secured by screwing or the like.

In an embodiment of the disclosure, the housing may include an outer shell, and an inner housing disposed in the outer shell. The outer shell and the inner housing may each include the main body and the electric wire insertion portion. The retainer securing portion may be inserted into the electric wire insertion portion of the outer shell. The retainer securing portion may include a coupling portion coupled with the electric wire insertion portion of the inner housing.

With this disclosure, the main body of the inner housing is disposed in the main body of the outer shell, and the electric wire insertion portion of the inner housing is disposed in the electric wire insertion portion of the outer shell. The electric wire is inserted from the electric wire insertion portion of the inner housing, and the harness-side terminal provided at the tip of the electric wire is disposed in the main body of the inner housing.

The retainer is secured to the outer shell by the retainer securing portion inserted into the electric wire insertion portion of the outer shell, and the electric wire insertion portion of the inner housing is coupled with the coupling portion of the retainer secured to the outer shell, so that the inner housing is secured to the outer shell via the retainer. In this manner, the outer shell and the inner housing secured to each other via the retainer may form a double-wall housing. With such a configuration, for example, a double-wall housing including the outer shell and the inner housing formed of different materials may be formed such that, for example, one of the outer shell and the inner housing is formed of a metal material having a shielding function whereas the other of the outer shell and the inner housing is formed of a resin.

In an embodiment of the disclosure, the retainer securing portion may be secured to the electric wire insertion portion of the outer shell.

With this disclosure, the inner housing may be firmly secured via the retainer including the retainer securing portion secured to the electric wire insertion portion of the outer shell.

In an embodiment of the disclosure, the coupling portion may allow the electric wire insertion portion of the inner housing to be press-fitted thereinto.

With this disclosure, the inner housing may be firmly coupled with the retainer.

In an embodiment of the disclosure, at least one of the coupling portion and a portion of the inner housing that is press-fitted into the coupling portion may have a crushing protrusion provided thereon, the crushing protrusion protruding in a direction crossing a press-fit direction in which the electric wire insertion portion of the inner housing is press-fitted into the coupling portion.

With this disclosure, the inner housing is press-fitted into the coupling portion, so that the crushing protrusion protruding in the direction crossing the press-fit direction is deformed. Therefore, the inner housing may be coupled with the retainer more firmly. The direction crossing the press-fit direction, in which the electric wire insertion portion of the inner housing is press-fitted into the coupling portion matches a thickness direction of the coupling portion into which the electric wire insertion portion of the inner housing is press-fitted.

In an embodiment of the disclosure, the connector may further include a housing seal sealing a space between the electric wire insertion portion of the inner housing and the electric wire insertion portion of the outer shell.

With this disclosure, the space between the electric wire insertion portion of the inner housing and the electric wire insertion portion of the outer shell is sealed. Therefore, foreign objects may be prevented from entering the connector through a path between the electric wire insertion portion of the inner housing and the electric wire insertion portion of the outer shell.

The retainer securing portion of the retainer is disposed in the electric wire insertion portion of the outer shell. Therefore, the housing seal may be prevented from being pulled off inadvertently.

### Advantageous Effects of Invention

The present disclosure provides a connector and a retainer that even if an electric wire is vibrated, suppress influence of the vibration on the connector.

### BRIEF DESCRIPTION OF DRAWINGS

FIG. 1A and FIG. 1B illustrate a connector connection structure.

FIG. 2A and FIG. 2B illustrate the connector connection structure in a divided state.

FIG. 3A and FIG. 3B illustrate the connector connection structure in a divided state.

FIG. 4 is an exploded perspective view of a device-side connector.

FIG. 5 is an exploded perspective view of a harness-side connector.

FIG. 6 is an exploded perspective view of the harness-side connector.

FIG. 7A through FIG. 7D illustrate a retainer.

FIG. 8A through FIG. 8D illustrate the retainer.

FIG. 9 is a cross-sectional view taken along line A-A in FIG. 1A.

FIG. 10A and FIG. 10B illustrate a procedure of assembling the harness-side connector.

FIG. 11A and FIG. 11B illustrate the procedure of assembling the harness-side connector.

FIG. 12A and FIG. 12B illustrate the procedure of assembling the harness-side connector.

FIG. 13A and FIG. 13B illustrate the procedure of assembling the harness-side connector.

FIG. 14A and FIG. 14B illustrate the procedure of assembling the harness-side connector.

FIG. 15 illustrates the procedure of assembling the harness-side connector.

### DESCRIPTION OF EMBODIMENTS

An embodiment of the present disclosure will be described in detail with reference to the drawings.

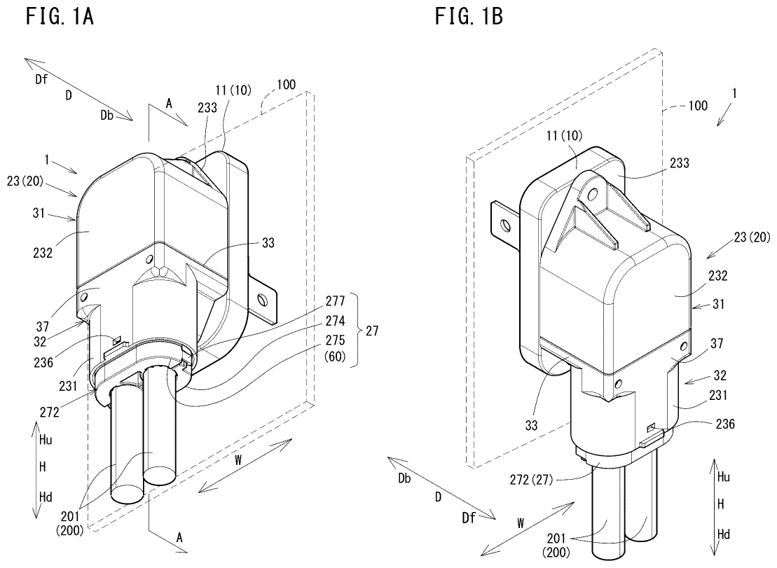

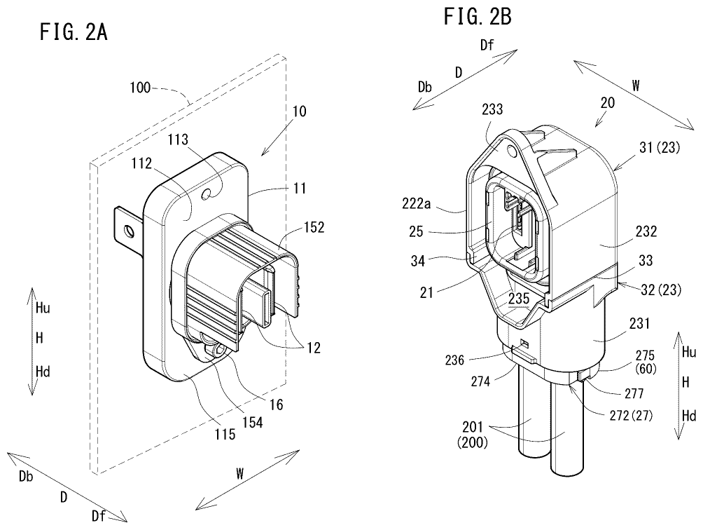

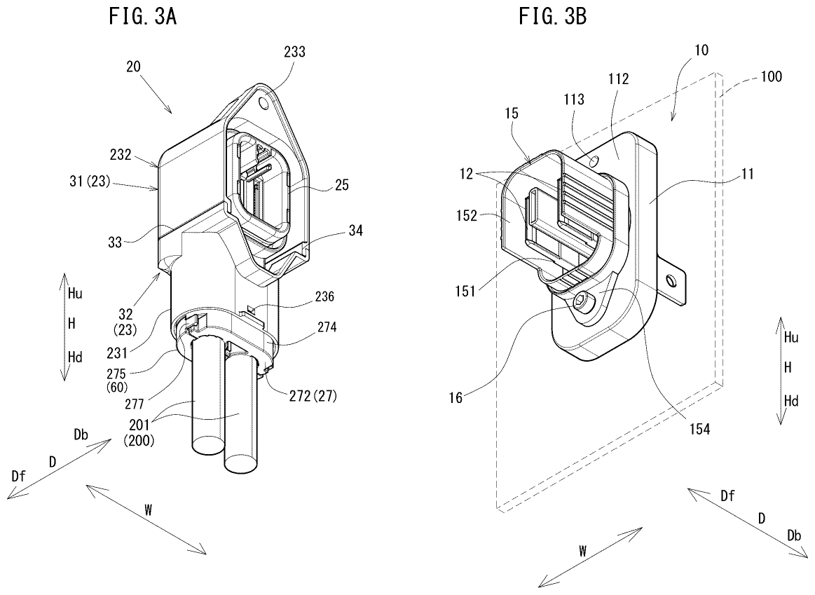

FIG. 1A and FIG. 1B each illustrate a connector connection structure 1, and FIG. 2A, FIG. 2B, FIG. 3A and FIG. 3B each illustrate the connector connection structure 1 in a divided state.

In more detail, FIG. 1A is a perspective view showing a front surface, a right side surface and a bottom surface of the connector connection structure 1, and FIG. 1B is a perspective view showing the front surface, a left side surface and a top surface of the connector connection structure 1.

FIG. 2A and FIG. 2B each show a perspective view illustrating the connector connection structure 1 in a divided state as seen from an upward side Hu. In more detail, FIG. 2A is a perspective view showing a front surface, a left side surface and a top surface of a device-side connector 10. FIG. 2B is a perspective view showing a rear surface, a left side surface and a top surface of a harness-side connector 20.

FIG. 3A and FIG. 3B are each a perspective view illustrating the connector connection structure 1 in a divided state as seen from a downward side Hd. In more detail, FIG. 3B is a perspective view showing the front surface, a right side surface and a bottom surface of the device-side connector 10. FIG. 3A is a perspective view showing the rear surface, a right side surface and a bottom surface of the harness-side connector 20.

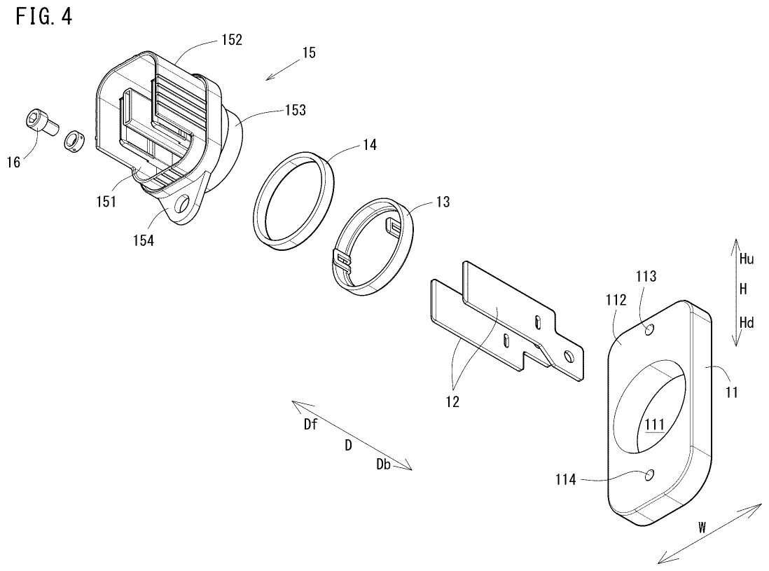

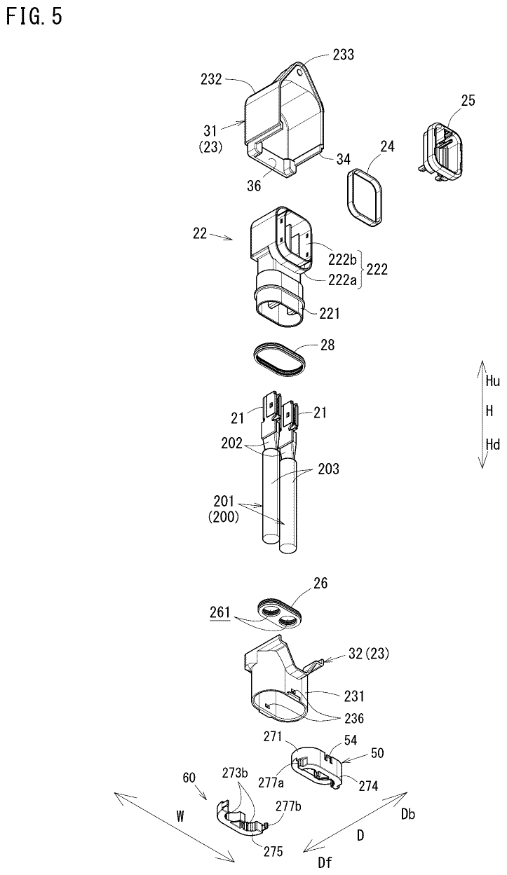

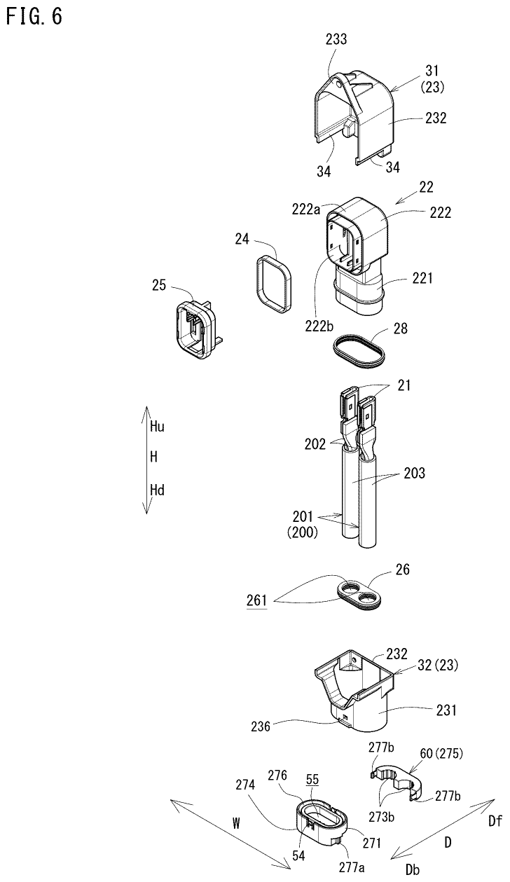

FIG. 4 is an exploded perspective view of the device-side connector 10 showing the front surface, the right side surface and the bottom surface thereof. FIG. 5 is an exploded perspective view of the harness-side connector 20 showing the rear surface, the right side surface and the bottom surface thereof. FIG. 6 is also an exploded perspective view of the harness-side connector 20 showing the rear surface, the left side surface and the top surface thereof.

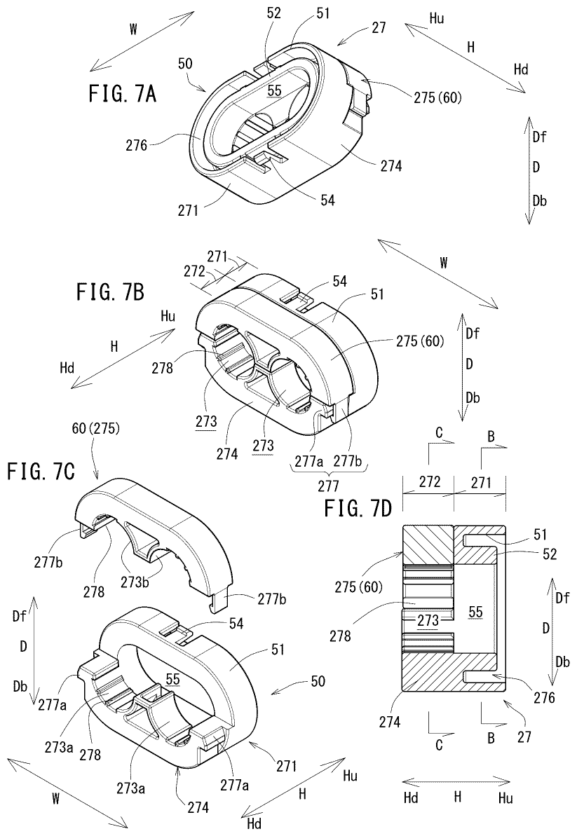

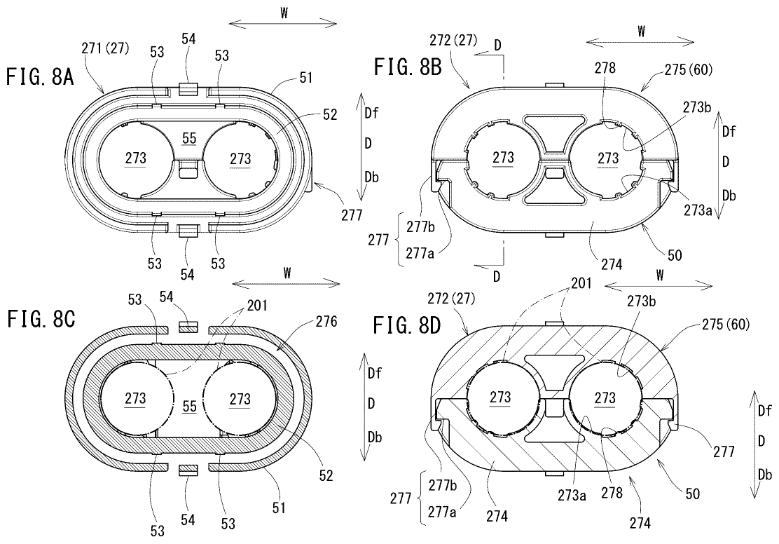

FIG. 7A through FIG. 7D and FIG. 8A through FIG. 8D illustrate a retainer 27. In more detail, FIG. 7A shows a rear surface, a top surface and a left side surface of the retainer 27, FIG. 7B shows a front surface, a bottom surface and a right side surface of the retainer 27, and FIG. 7C shows the front surface, the bottom surface and the right side surface of the retainer 27 in a divided state, and FIG. 7D is a cross-sectional view taken along line D-D in FIG. 8B.

FIG. 8A is a top view of the retainer 27, and FIG. 8B is a bottom view of the retainer 27. FIG. 8C is a cross-sectional view taken along line B-B in FIG. 7D, and FIG. 8D is a cross-sectional view taken along line C-C in FIG. 7D. FIG. 8C and FIG. 8D each show high-voltage electric wires 201, to which the retainer 27 is to be attached, with phantom lines.

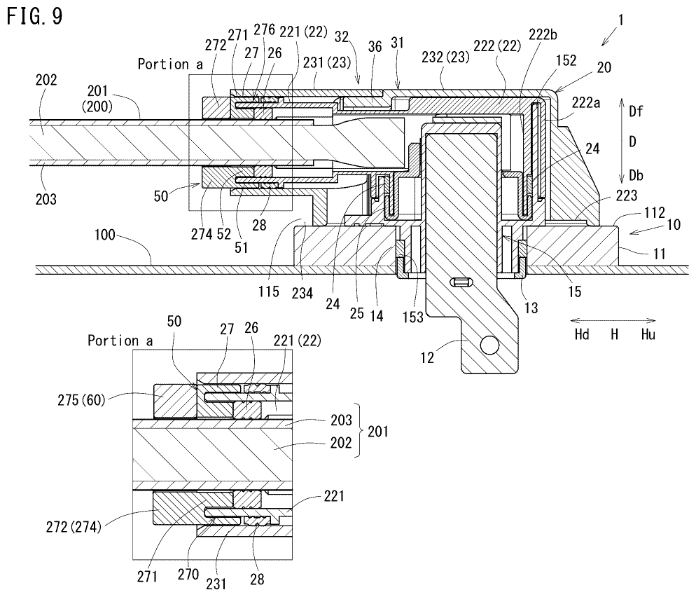

FIG. 9 shows a cross-sectional view taken along line A-A in FIG. 1A and an enlarged view of part “a”.

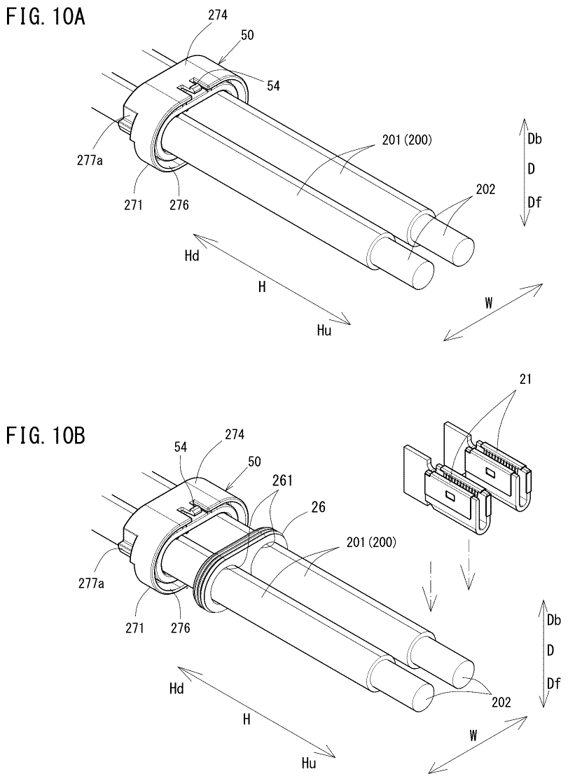

FIG. 10A through FIG. 15 illustrate a procedure of assembling the harness-side connector 20.

In more detail, FIG. 10A is a perspective view, as seen from the side of the rear surface, of a state where a retainer main body 50 included in the retainer 27 is outserted over a wire harness 200 in advance. FIG. 10B is a perspective view, as seen from the side of the rear surface, of a state where a wire seal 26 is outserted over the wire harness 200 in advance but harness-side terminals 21 have not been attached yet.

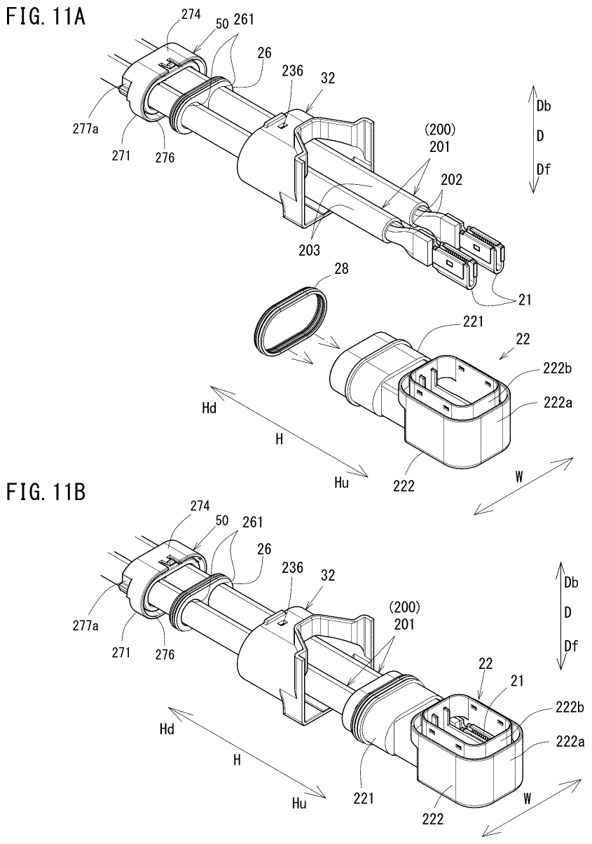

FIG. 11A is a perspective view, as seen from the side of the rear surface, of a state where the harness-side terminals 21 are attached to electric wires 202 at a tip of the wire harness 200 and a lower shell 32 included in a housing shell 23 is outserted over the wire harness 200 in advance, but a shell seal 28 has not been attached yet to a harness insertion cylinder 221 of a female inner housing 22 yet. FIG. 11B is a perspective view of a state where the female inner housing 22 having the shell seal 28 attached thereto is attached to the wire harness 200.

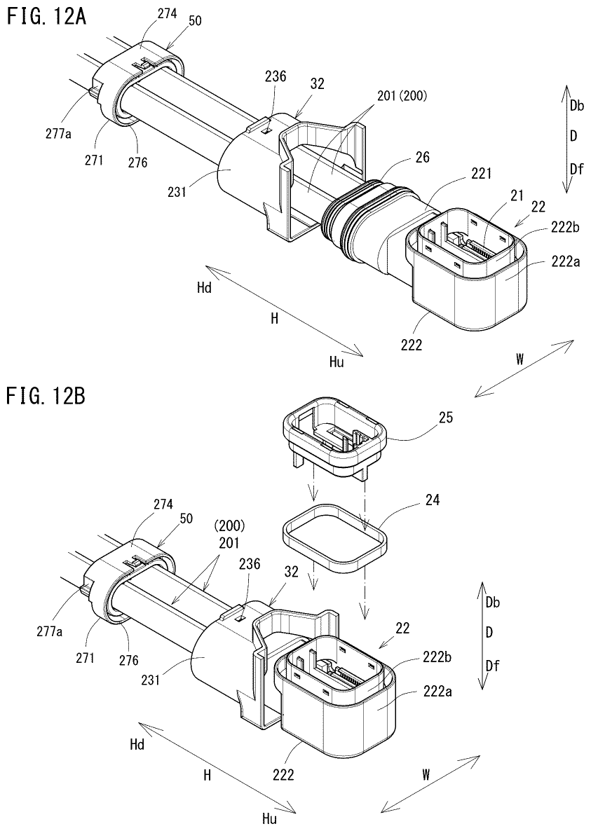

FIG. 12A is a perspective view, as seen from the side of the rear surface, of a state where the wire seal 26 outserted in advance is disposed at a predetermined position. FIG. 12B is a perspective view, as seen from the side of the rear surface, of a state where the lower shell 32 is disposed at a predetermined position with respect to the above-attached female inner housing 22 but neither a housing seal 24 nor a housing seal cover 25 has been attached yet.

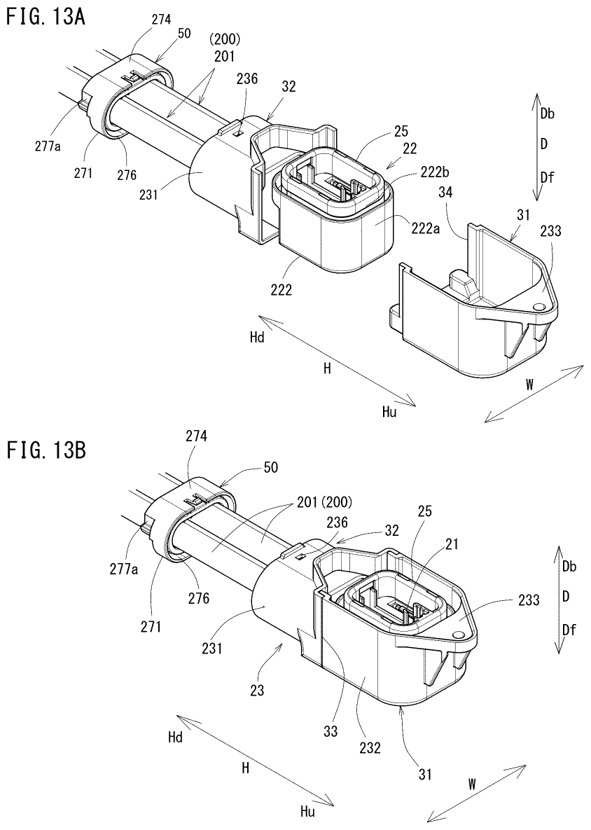

FIG. 13A is a perspective view, as seen from the side of the rear surface, of a state where the housing seal 24 and the housing seal cover 25 are attached to the female inner housing 22 but an upper shell 31, forming the housing shell 23 together with the lower shell 32, has not been attached yet.

FIG. 13B is a perspective view, as seen from the side of the rear surface, of a state where the upper shell 31 is attached to the lower shell 32 disposed at the predetermined position.

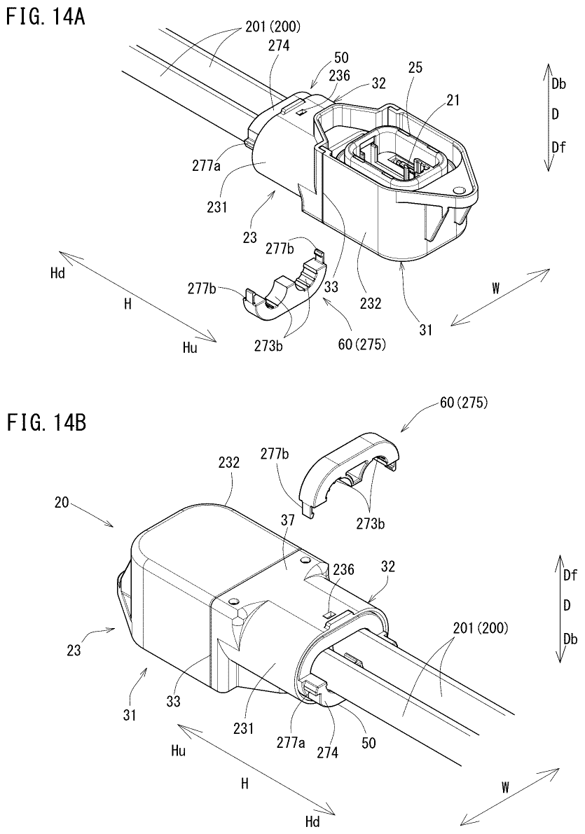

FIG. 14A is a perspective view, as seen from the side of the rear surface, of a state where the retainer main body 50 included in the retainer 27 is attached to a predetermined position but a retainer cover 60 included in the retainer 27 has not been attached yet. FIG. 14B is a perspective view, as seen from the side of the front surface, of the same state, that is, the state where the retainer main body 50 included in the retainer 27 is attached to the predetermined position but the retainer cover 60 included in the retainer 27 has not been attached yet.

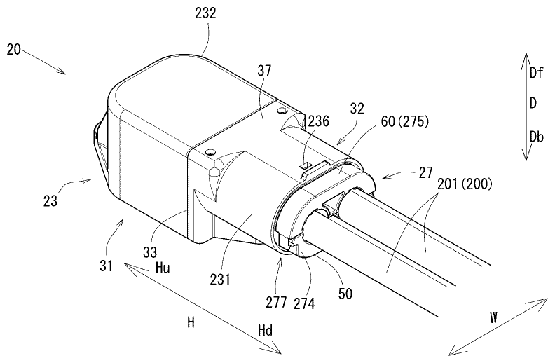

FIG. 15 is a perspective view, as seen from the side of the front surface, of a state where the retainer cover 60 is attached to the retainer main body 50 and thus the assembly of the harness-side connector 20 is finished.

In FIG. 1A, arrows H extending in an up-down direction represent a height direction, arrows W extending from bottom-left to top-right represent a width direction, and arrows D extending from bottom-right to top-left represent a depth direction. Arrow Hu of the arrows H extending in the up-down direction represents an upward side of the height direction, and arrow Hd of the arrows H extending in the up-down direction represents a downward side of the height direction. Arrow Db of the arrows D extending from bottom-right to top-left represents a backward side of the depth direction, and arrow Df of the arrows D extending from bottom-right to top-left represents a forward side of the depth direction.

The height direction H, the width direction W and the depth direction D used to describe the configuration of the connector connection structure 1 represent the following directions for the sake of convenience. The depth direction D is a direction in which the device-side connector 10 and the hardness-side connector 20 are attached to, or detached from, each other. The backward side Db is a direction in which the harness-side connector 20 is attached to the device-side connector 10, and the forward side Df is a direction in which the harness-side connector 20 is detached from the device-side connector 10. The width direction W and the height direction H are perpendicular to the depth direction D. These directions do not restrict any direction regarding the configurations of the device-side connector 10, the hardness-side connector 20 and the connector connection structure 1.

As shown in FIG. 1A and FIG. 1B, a connector connection structure 1 is to connect, for example, a device-side connector 10 provided in a device mounted on an automobile, such as an electric device, i.e., a motor or the like, or a power supply device, and a harness-side connector 20 attached to a wire harness 200 including a bundle of covered electric wires, to each other.

As shown in FIG. 2A, FIG. 2B, FIG. 3A and FIG. 3B, the device-side connector 10 is attached to a device housing 100 of the electric device (represented with dashed lines in FIG. 2A and FIG. 3B).

As shown in FIG. 4, the device-side connector 10 includes an attachment pedestal 11, device-side terminals 12, a restriction ring 13, a device-side seal 14, a male housing 15, and a securing bolt 16.

The attachment pedestal 11 is to be attached to the device housing 100 represented with the dashed line and thus to secure the male housing 15 and the harness-side connector 20 described below.

The attachment pedestal 11 has a rectangular shape longer in the height direction H than in the width direction W, and has a predetermined thickness in the depth direction D. The attachment pedestal 11 has a through-hole 111 running therethrough in the depth direction D at a center as seen from the side of the front surface.

A portion of the attachment pedestal 11 that is on the upward side Hu with respect to the through-hole 111 is defined as a securing portion 112 securing the harness-side connector 20 to be attached thereto. The securing portion 112 has a tightening hole 113, through which the harness-side connector 20 is to be secured to the attachment pedestal 11 with a bolt.

A portion of the attachment pedestal 11 that is on the downward side Hd with respect to the through-hole 111 has a tightening hole 114, through which the male housing 15 is to be secured to the attachment pedestal 11 with a securing bolt 16.

The attachment pedestal 11 having such a configuration is formed of a metal material so as to be connected with the harness-side connector 20 described above in an electrically conductive manner and thus provide an electromagnetic shield function when the harness-side connector 20 is attached to the attachment pedestal 11.

The device-side terminals 12 are to be electrically connected with a main body of the electric device disposed in the device housing 100 and are also to be connected with harness-side terminals 21 disposed in the harness-side connector 20. There are two device-side terminals 12 that are away from each other by a predetermined interval in the width direction W.

The restriction ring 13 is to restrict the position, in the depth direction D, of the device-side seal 14 to be attached to an insertion cylinder 153 of the male housing 15 described below, and has a cylindrical shape to be outserted over the insertion cylinder 153.

The device-side seal 14 is to be attached to the insertion cylinder 153 of the male housing 15 described below, and thus to seal a space between the insertion cylinder 153 of the male housing 15 and the attachment pedestal 11. The device-side seal 14 is ring-shaped and formed of rubber.

The male housing 15 is to retain the device-side terminals 12 to the attachment pedestal 11. The male housing 15 includes a retaining portion 151 retaining the device-side terminals 12, a hood 152 enclosing the retaining portion 151, the insertion cylinder 153, of a cylindrical shape, to be inserted into the through-hole 111 of the attachment pedestal 11, and a securing protrusion 154, which protrudes toward the downward side Hd in the height direction H, and to which the securing bolt 16 is to be attached to secure the male housing 15 to the attachment pedestal 11.

The retaining portion 151 is configured to retain the device-side terminals 12, disposed to be away from each other by the predetermined interval in the width direction W, in a state where the device-side terminals 12 are insulated from each other.

The hood 152 has a shape of an enclosing wall with an opening formed on the forward side Df.

The device-side connector 10 having such a configuration is assembled as follows. The device-side terminals 12 are put into the retaining portion 151 of the male housing 15, and the device-side seal 14 and the restriction ring 13 are outserted over the insertion cylinder 153.

Then, the insertion cylinder 153 of the male housing 15 having the device-terminals 12, the restriction ring 13 and the device-side seal 14 assembled thereto is inserted into the through-hole 111 of the attachment pedestal 11, and the securing bolt 16 attached to the securing protrusion 154 is screwed into the tightening hole 114. As a result, the attachment pedestal 11 and the male housing 15 are secured to each other. Thus, the assembly of the device-side connector 10 is finished.

The harness-side connector 20 is to be attached to the above-described device-side connector 10 to form the connector connection structure 1. The harness-side connector 20 connects the device-side terminals 12 of the device-side connector 10 and the harness-side terminals 21 of the harness-side connector 20 to each other.

The harness-side connector 20 includes a wire harness 200, the harness-side terminals 21 attached to tips of high-voltage electric wires 201 included in the wire harness 200, a female inner housing 22, an housing shell 23, a housing seal 24, a housing seal cover 25, a wire seal 26, a retainer 27, and a shell seal 28.

The harness-side terminals 21 are high-voltage terminals attached to electric wires 202 exposed from the tips of the high-voltage electric wires 201 each including an electric wire 202 and an insulating cover 203 covering the electric wire 202. In the case where the wire harness 200 includes two high-voltage electric wires 201, one harness-side terminal 21 is attached to each of the high-voltage electric wires 201, and thus the harness-side connector 20 includes two harness-side terminals 21.

The female inner housing 22 is to retain the two harness-side terminals 21 at predetermined positions in the harness-side connector 20. The female inner housing 22 includes a harness insertion cylinder 221, into which the wire harness 200 is to be inserted, and a retaining portion main body 222, in which the harness-side terminals 21, provided at a tip of the wire harness 200 inserted into the harness insertion cylinder 221, are to be disposed. The female inner housing 22 is formed of a resin.

The harness insertion cylinder 221 has a cylindrical shape that has an opening at an end on the downward side Hd (bottom end) and has an elliptical shape (ellipsoidal shape with two straight portions) as seen from the side of the bottom surface. An end on the upward Hu (top end) of the harness insertion cylinder 221 is in communication with the inside of the retaining portion main body 222.

The retaining portion main body 222 is disposed at the top end of the harness insertion cylinder 221, and has a generally cuboidal shape with an opening formed on the backward side Db. The retaining portion main body 222 is configured to retain the harness-side terminals 21 therein.

The retaining portion main body 222 includes an outer wall 222a and an inner wall 222b, and is configured to retain the harness-side terminals 21 inside the inner wall 222b.

Between the outer wall 222a and the inner wall 222b, there is a space into which the hood 152 of the male housing 15 of the device-side connector 10 is to be inserted, in a state where the device-side connector 10 and the harness-side connector 20 are assembled together.

The housing shell 23 is to cover an outer surface of the female inner housing 22 and is to form an outer shape of the harness-side connector 20.

The housing shell 23 has a shape similar to that of the female inner housing 22 and is larger than the female inner housing 22 to some extent. The housing shell 23 includes a harness insertion outer cylinder 231, a shell main body 232, and a connector securing portion 233.

This will be described in more detail. The harness insertion outer cylinder 231 has a cylindrical shape that is elliptical as seen from the side of the bottom surface and has an opening formed at a bottom end thereof. The harness insertion outer cylinder 231 is larger than the harness insertion cylinder 221 to some extent such that the harness insertion cylinder 221, into which the wire harness 200 is to be inserted, is disposed in the harness insertion outer cylinder 231. A top end of the harness insertion outer cylinder 231 is in communication with the inside of the shell main body 232. The harness insertion outer cylinder 231 has engaging openings 236 respectively formed in two surfaces thereof in the depth direction D. Engaging locks 54 of the retainer 27 described below are to be engaged with the engaging openings 236.

The shell main body 232 is to be disposed at the top end of the harness insertion outer cylinder 231. The shell main body 232 has a generally cuboidal shape with an opening formed on the backward side Db. The shell main body 232 is larger, to some extent, than the retaining portion main body 222 to be disposed therein.

The opening formed on the backward side Db of the shell main body 232 having the generally cuboidal shape is a fitting opening 235, from which the harness-side terminals 21 are exposed.

The connector securing portion 233 is triangular as seen from the side of the front surface and protrudes toward the upward side Hu from the shell main body 232. The connector securing portion 233 has a plate-like shape, and a bolt (not shown) is to be attached to the connector securing portion 233 to secure the housing shell 23 to the attachment pedestal 11.

The housing shell 23 enclosing the female inner housing 22 is formed of a metal material so as to be electrically conductive with the attachment pedestal 11 and provide an electromagnetic shield function when the housing shell 23 is attached to the attachment pedestal 11 and the connector securing portion 233 is secured, with a bolt, to the securing portion 112 of the attachment pedestal 11.

The housing shell 23 having such a configuration is assembled as follows. Divided shells 31 and 32, which are parts of the shell main body 232 separated from each other in the height direction H, are assembled together.

This will be described in more detail. The shell main body 232 is divided into two along a phantom horizontal plane (not shown) extending in the width direction W and the depth direction D into the upper shell 31 on the upward side Hu with respect to the phantom horizontal plane and the lower shell 32 on the downward side Hd with respect to the phantom horizontal plane. The upper shell 31 and the lower shell 32 are assembled together in the height direction H. The phantom horizontal plane is at a position close to the top end of the harness insertion cylinder 221 in the state where the harness-side connector 20 is assembled.

The portion of the shell main body 232 on the upward side Hu with respect to the phantom horizontal plane and the connector securing portion 233 form the upper shell 31, and the portion of the shell main body 232 on the downward side Hd with respect to the phantom horizontal plane and the harness insertion outer cylinder 231 form the lower shell 32. The upper shell 31 and the lower shell 32 are assembled together in the height direction H, along a joining portion 33, to form the housing shell 23.

A bottom portion, of the upper shell 31, that is included in the joining portion 33 and a top portion, of the lower shell 32, that is included in the joining portion 33 each have a sharp-cornered U shape that is opened toward the backward side Db in the depth direction D as seen in the height direction H. Joining protrusions 34 are formed along edges, among edges of the sharp-cornered U shape, on two side surfaces in the width direction W. The joining protrusions 34 are put along inner surfaces of the top portion of the lower shell 32 to form the joining portion 33.

This will be described in more detail. The upper shell 31 has the sharp-cornered U shape as seen from the side of the bottom surface. The side surfaces on the two sides of the upper shell 31 in the width direction W have the edges on the downward side Hd. The joining protrusions 34 are formed along inner surfaces of these edges so as to protrude toward the downward side Hd.

As described above, the joining protrusions 34 are put along the inner surfaces of the top portion of the lower shell 32, and the upper shell 31 and the lower shell 32 are joined and assembled together to form the shell main body 232. The upper shell 31, the lower shell 32 and the joining portion 33 of the shell main body 232 thus assembled are flush with each other.

In the upper shell 31 having the sharp-cornered U shape as seen from the side of the bottom surface, a conductive connection piece 36 is provided along an inner surface of an edge on the downward side Hd on the backward side Db. The conductive connection piece 36 protrudes toward the downward side Hd. The connection protrusions 34 provided on the two sides in the width direction W and protruding from the bottom end of the upper shell 31 and the conductive connection piece 36 are continuous to each other, and the conductive connection piece 36 has bolt holes to which securing bolts are to be engaged.

In the state where the upper shell 31 and the lower shell 32 are assembled together, the conductive connection piece 36 having such a configuration is disposed on the inner side surface on the backward side Db of the lower shell 32, and is tightened with the bolts. In this manner, a conductive connection portion 37 (see FIG. 1A and FIG. 1B), which connects the upper shell 31 and the lower shell 32 to each other in an electrically conductive manner, is formed.

The housing seal 24 has a ring shape that is quadrangular as seen from the side of the front surface, and the quadrangular shape of the housing seal 24 matches the shape of the inner wall 222b of the retaining portion main body 222 as seen from the side of the rear surface. The housing seal 24 is formed of rubber.

The housing seal 24 is to be outserted over the inner wall 222b of the female inner housing 22 and thus to seal a space between the male housing 15 of the device-side connector 10 and the female inner housing 22 of the harness-side connector 20 in the state where the device-side connector 10 and the harness-side connector 20 are assembled together.

The housing seal cover 25 is to be attached to the inner wall 222b of the female inner housing 22 from the backward side Db in the depth direction D, and thus to secure the harness-side terminals 21 disposed in the retaining portion main body 222 of the female inner housing 22.

The wire seal 26 has holes 261, into which the two high-voltage electric wires 201 are to be inserted. The wire seal 26 is to seal a space between the high-voltage electric wires 201 inserted into the harness insertion cylinder 221 and an inner surface of the harness insertion cylinder 221. Therefore, the wire seal 26 is formed to be elliptical so as to be disposed in the harness insertion cylinder 221.

The shell seal 28 is to be outserted over the harness insertion cylinder 221 of the female inner housing 22 and thus to seal a space between the harness insertion cylinder 221 and the harness insertion outer cylinder 231. The shell seal 28 is formed to be elliptical so as to be outserted over the harness insertion cylinder 221.

The retainer 27 is to retain the high-voltage electric wires 201 inserted into the harness insertion cylinder 221 to the harness insertion outer cylinder 231, and has holes into which the two high-voltage electric wires 201 are to be inserted.

As shown in FIG. 7A through FIG. 8D, the retainer 27 includes a retainer securing portion 271 to be inserted into, and secured to, the harness insertion outer cylinder 231, and an electric wire retaining portion 272 protruding from the harness insertion outer cylinder 231. The electric wire retaining portion 272 is to retain the high-voltage electric wires 201. Regarding the retainer 27, the retainer securing portion 271 and the electric wire retaining portion 272 are formed to have substantially the same length as each other in an insertion direction (height direction H) in which the high-voltage electric wires 201 are to be inserted.

The electric wire retaining portion 272 has electric wire insertion holes 273, in which the inserted high-voltage electric wires 201 are to be retained. The electric wire retaining portion 272 includes a securing-side retaining portion 274 integrally formed with the retainer securing portion 271, and an attachment retaining portion 275 to be attached to the securing-side retaining portion 274. The retainer securing portion 271 includes a press-fit coupling portion 276, to which a bottom portion of the harness insertion cylinder 221 is to be coupled.

The securing-side retaining portion 274 has securing-side arcked grooves 273a, each of which is a half of the corresponding electric wire insertion hole 273 on the backward side Db, and the attachment retaining portion 275 has attachment-side arcked grooves 273b, each of which is a half of the corresponding electric wire insertion hole 273 on the forward side Df.

Two electric wire insertion holes 273 are provided, in correspondence with the two high-voltage electric wires 201 included in the wire harness 200, to be away from each other by a predetermined interval in the width direction W. The electric wire insertion holes 273 are each formed to have a diameter equal to, or slightly shorter than, an outer diameter of the corresponding high-voltage electric wire 201, and an inner surface of each of the electric wire insertion holes 273 has ribs 278 formed thereon, which eat into an outer surface of the corresponding high-voltage electric wire 201, that is, the corresponding insulating cover 203.

Specifically, the retainer 27 is formed to have an elliptical cylindrical shape such that a part thereof is insertable into the harness insertion outer cylinder 231. The retainer 27 includes two components, that is, a retainer main body 50 including the retainer securing portion 271 and the securing-side retaining portion 274, and a retainer cover 60 acting as the attachment retaining portion 275.

The retainer main body 50 includes an outer cylinder 51 included in the retainer securing portion 271, an inner cylinder 52 disposed away from the outer cylinder 51 by a predetermined interval, and the securing-side retaining portion 274 protruding toward the downward side Hd. The outer cylinder 51, the inner cylinder 52 and the securing-side retaining portion 274 are integrally formed together.

The outer cylinder 51 is formed to be elliptical so as to be outserted over the bottom portion of the harness insertion cylinder 221 of the female inner housing 22. The inner cylinder 52 is disposed away from the outer cylinder 51 by an interval corresponding to the thickness of the harness insertion cylinder 221. The outer cylinder 51 and the inner cylinder 52 form the press-fit coupling portion 276, which is to be press-fit-coupled with the bottom portion of the harness insertion cylinder 221.

An insertion space 55 having an elliptic cylindrical shape is formed in the inner cylinder 52. Arcked portions of an inner surface, of the inner cylinder 52, that form the inner cylinder 52 each have a diameter larger, by some extent, than the outer diameter of the corresponding high-voltage electric wire 201 of the wire harness 200, which is to be inserted into the insertion space 55.

An outer surface of the inner cylinder 52 has crushing ribs 53 formed thereon. The crushing ribs 53 protrude toward the outer cylinder 51 and extend in a press-fit direction (height direction H) in which the harness insertion cylinder 221 is press-fitted into the press-fit coupling portion 276. A plurality of the crushing ribs 53 are provided on a straight portion of the elliptical inner cylinder 52, so as to be away from each other by a predetermined interval.

The outer cylinder 51 has the engaging locks 54 at positions corresponding to the engaging openings 236 provided in the harness insertion outer cylinder 231. The engaging locks 54 are to be respectively engaged with the engaging openings 236. The engaging locks 54 are insertable into the engaging openings 236 toward the upward side Hu, and each have a shape of claw engageable on the downward side Hd.

The securing-side retaining portion 274, protruding toward the downward side Hd in a state of being attached to the retainer securing portion 271 including the outer cylinder 51 and the inner cylinder 52, is formed to have a generally semi-elliptical shape, that is, a generally semi-oval shape that is the same as that of a half of the elliptical retainer securing portion 271. The securing-side retaining portion 274 has the securing-side arcked grooves 273a each forming generally a half of the corresponding electric wire insertion hole 273 and securing hooks 277a included in engaging securing portions 277, which are to be engaged with, and thus to secure, the retainer cover 60.

The two semi-circular securing-side arcked grooves 273a, each of which is generally a half of the corresponding electric wire insertion hole 273, are provided to be away from each other by a predetermined interval in the width direction W. The securing hooks 277a are each provided outer to the corresponding securing-side arcked groove 273a in the width direction W. An inner surface forming each of the securing-side arcked grooves 273a has a plurality of ribs 278, extending in the height direction H, to be away from each other by a predetermined interval in a circumferential direction of the inner surface.

An outer circumferential surface of the securing-side retaining portion 274 has the same shape as that of a half of an outer circumferential surface of the retainer securing portion 271.

The attachment retaining portion 275, that is, the retainer cover 60 to be combined with the securing-side retaining portion 274, formed to have a generally semi-elliptical shape, that is, a generally semi-oval shape, to form the electric wire retaining portion 272 is formed to have a generally semi-elliptical shape, that is, a generally semi-oval shape that is generally symmetrical to the securing-side retaining portion 274.

The retainer cover 60 acting as the attachment retaining portion 275 has the generally semi-circular attachment-side arcked grooves 273b and attachment-side hooks 277b. Each of the attachment-side arcked grooves 273b is generally a half of the corresponding electric wire insertion holes 273, and is to be combined with the corresponding securing-side arcked groove 273a formed in the securing-side retaining portion 274 to form the corresponding electric wire insertion hole 273. The attachment-side hooks 277b each included in the corresponding engaging securing portion 277, which is to be engaged with the retainer cover 60 and thus to secure the retainer cover 60 to the retainer main body 50.

Two attachment-side arcked grooves 273b each of which is to be combined with the corresponding securing-side arcked groove 273a to form the corresponding electric wire insertion holes 273 are provided, in correspondence with the securing-side arcked grooves 273a, to be away from each other by a predetermined interval in the width direction W. The attachment-side hooks 277b are each provided outer to the corresponding attachment-side arcked groove 273b in the width direction W. An inner surface forming each attachment-side arcked grooves 273b has a plurality of ribs 278 formed thereon, which are away from each other by a predetermined interval in a circumferential direction of the inner surface as in the case of the securing-side arcked grooves 273a.

An outer circumferential surface of the retainer cover 60 acting as the attachment retaining portion 275 has the same shape as that of a half of the outer circumferential surface of the retainer securing portion 271.

The above-described elements may be assembled as described below to form the harness-side connector 20.

The housing seal 24 is outserted over the inner wall 222b of the retaining portion main body 222 of the female inner housing 22 and is disposed between the outer wall 222a and the inner wall 222b. The housing cover seal 25 is attached to an opening side of the inner wall 222b.

The high-voltage electric wires 201 are inserted through the holes 261 of the wire seal 26, and the wire seal 26 is attached to the wire harness 200. The shell seal 28 is outserted over the harness insertion cylinder 221 of the female inner housing 22.

The wire harness 200 including the high-voltage electric wires 201 having the harness-side terminals 21 attached at the tips thereof is inserted into the harness insertion cylinder 221 of the female inner housing 22, and attached to the female inner housing 22 such that the harness-side terminals 21 are disposed in the retaining portion main body 222.

The female inner housing 22 is disposed in the housing shell 23 including the upper shell 31 and the lower shell 32 assembled together at the joining portion 33. The retaining portion main body 222 of the female inner housing 22 is disposed in the shell main body 232, and the harness insertion cylinder 221 is disposed in the harness insertion outer cylinder 231. At this point, the bottom portion of the harness insertion cylinder 221 is disposed on the upward side Hu with respect to a bottom portion of the harness insertion outer cylinder 231.

The retainer 27 outserted over the wire harness 200 is disposed in a portion, of the harness insertion outer cylinder 231, that is on the downward side Hd. Specifically, the retainer securing portion 271 is disposed on the downward side Hd with respect to the bottom portion of the harness insertion cylinder 221, which is disposed in the harness insertion outer cylinder 231. The electric wire retaining portion 272 is attached to the harness insertion outer cylinder 231 so as to protrude toward the downward side Hd from the bottom portion of the harness insertion outer cylinder 231.

At this point, the engaging locks 54 of the retainer main body 50 including the retainer securing portion 271 are put into engagement with the engaging openings 236 provided in the harness insertion outer cylinder 231 and thus are secured to the harness insertion outer cylinder 231.

The bottom portion of the harness insertion cylinder 221 is press-fitted into the press-fit coupling portion 276 provided in the retainer securing portion 271, and thus the female inner housing 22 and the retainer 27 are coupled with each other. When the bottom portion of the harness insertion cylinder 221 is press-fitted into the press-fit coupling portion 276, the crushing ribs 53 of the retainer main body 50 including the retainer securing portion 271 are deformed by the harness insertion cylinder 221, and thus the harness insertion cylinder 221 and the press-fit coupling portion 276 are firmly coupled with each other.

Regarding the electric wire retaining portion 272 of the retainer 27 including the retainer main body 50 and the retainer cover 60 assembled together, the ribs 278 provided on an inner surface, of the electric wire retaining portion 272, that forms the electric wire insertion holes 273 locally press outer circumferential surfaces of the high-voltage electric wires 201 inserted through the electric wire insertion holes 273, and thus the high-voltage electric wires 201 are secured to the harness insertion outer cylinder 231. The retainer 27 including the press-fit coupling portion 276, to which the harness insertion cylinder 221 is press-fitted, and the high-voltage electric wires 201 are secured to each other.

The harness-side connector 20 assembled in this manner and the device-side connector 10 are fitted into each other, and the device-side terminals 12 of the device-side connector 10 and the harness-side terminals 21 disposed in the retaining portion main body 222 of the harness-side connector 20 are connected with each other. In this manner, the connector connection structure 1 including the device-side connector 10 and the harness-side connector 20 electrically conductive to each other is formed.

A procedure of assembling the harness-side connector 20, which is to be fitted to the device-side connector 10 as described above to form the connector connection structure 1, will be described with reference to FIG. 10A through FIG. 15.

The procedure will be described in detail. First, as shown in FIG. 10A, the retainer main body 50 included in the retainer 27 is outserted over the wire harness 200 in advance. As shown in FIG. 10B, the high-voltage electric wires 201 are inserted through the holes 261, and the wire seal 26 is outserted over the high-voltage electric wires 201 in advance. At this point, the high-voltage electric wires 201 included in the wire harness 200 do not have the harness-side terminals 21 attached to at the tips thereof, and the electric wires 202 are exposed at the tips.

As shown in FIG. 11A, the harness-side terminals 21 are attached to the electric wires 202 at the tip of the wire harness 200, and the lower shell 32 included in the housing shell 23 is outserted over the wire harness 200 in advance. Then, the shell seal 28 is attached to the harness insertion cylinder 221 of the female inner housing 22.

The attachment of the shell seal 28 to the harness insertion cylinder 221 and the attachment of the lower shell 32 to the wire harness 200 may be performed at any time by the next step of attaching the female inner housing 22 to the wire harness 200.

The harness-side terminals 21 may be attached to the electric wires 202 exposed from the tips of the high-voltage electric wires 201 by, for example, ultrasonic vibration welding or the like. The above description is made with an assumption that until the step of attaching the harness-side terminals 21 to the electric wires 202 exposed from the tips of the high-voltage electric wires 201, the electric wires 202 are exposed from the tips of the high-voltage electric wires 201. Alternatively, in the step of attaching the harness-side terminals 21, the insulating covers 203 at the tips may be slipped by a predetermined length to expose the electric wires 202, and then the harness-side terminals 21 may be attached.

As shown in FIG. 11B, the female inner housing 22 having the shell seal 28 attached thereto is attached to the wire harness 200. As shown in FIG. 12A, the wire seal 26 outserted in advance is disposed at a predetermined position with respect to the high-voltage electric wires 201 having the harness-side terminals 21 attached to the tips thereof.

The predetermined position is the position at which the wire seal 26 is inserted from the bottom end of the harness insertion cylinder 221 toward the upward side Hu. At this position, the wire seal 26 seals a space between the high-voltage electric wires 201 inserted through the holes 261 and the harness insertion cylinder 221.

Next, as shown in FIG. 12B, the lower shell 32 is disposed at a predetermined position with respect to the above-attached female inner housing 22. The housing seal 24 and the housing seal cover 25 are attached to the inner wall 222b of the female inner housing 22 (see FIG. 13A). The attachment of the housing seal 24 and the housing seal cover 25 to the inner wall 222b of the female inner housing 22 may be performed at any time after the female inner housing 22 is attached to the high-voltage electric wires 201.

As shown in FIG. 13B, the joining protrusions 34 are put along a circumferential edge of the lower shell 32 disposed at the predetermined position, and the upper shell 31 is fitted into, and attached to, the lower shell 32 by the joining portion 33. At this point, the conductive connection piece 36 on the forward side Df of the upper shell 31 and the lower shell 32 are tightened together by a bolt (not shown), and thus the upper shell 31 and the lower shell 32 are assembled together and secured to each other. As a result, the housing shell 23 is formed.

As shown in FIG. 14A and FIG. 14B, the retainer main body 50 included in the retainer 27 is attached to a predetermined position with respect to the harness insertion outer cylinder 231 of the housing shell 23 formed by the upper shell 31 and the lower shell 32 being secured to each other.

This will be described in more detail. The retainer securing portion 271 of the retainer main body 50, which is to be assembled with the retainer cover 60 to form the retainer 27, is inserted into the harness insertion outer cylinder 231, and the engaging locks 54 are put into engagement with the engaging openings 236 formed in the harness insertion outer cylinder 231 to secure the retainer main body 50 to the harness insertion outer cylinder 231. In this state, the bottom portion of the harness insertion cylinder 221 is press-fitted into the press-fit coupling portion 276 of the retainer main body 50, and thus the retainer main body 50 and the female inner housing 22 are integrated together. The high-voltage electric wires 201 are merely inserted through the insertion space 55 of the retainer securing portion 271 and disposed in the securing-side arcked grooves 273a of the securing-side retaining portion 274, and are not secured to the retainer 27.

In this state, as shown in FIG. 14A and FIG. 14B, the securing-side retaining portion 274 included in the electric wire retaining portion 272 of the retainer main body 50 protrudes from the harness insertion outer cylinder 231.

As shown in FIG. 15, the retainer cover 60 acting as the attachment retaining portion 275 is attached to the securing-side retaining portion 274, of the retainer main body 50, protruding from the harness insertion outer cylinder 231. The securing hooks 277a of the retainer main body 50 and the attachment-side hooks 277b of the retainer cover 60 are put into engagement with each other to form the engaging securing portions 277. In this manner, the retainer main body 50 and the retainer cover 60 are secured to each other to form the retainer 27. Thus, the assembly of the harness-side connector 20 is finished.

As can be seen, in the retainer 27 including the retainer main body 50 and the retainer cover 60 assembled together, the securing-side arcked grooves 273a provided in the securing-side retaining portion 274 and the attachment-side arcked grooves 273b provided in the attachment retaining portion 275 form the electric wire insertion holes 273. The ribs 278 presses the insulating covers 203 of the high-voltage electric wires 201 inserted through the electric wire insertion holes 273, and thus the high-voltage electric wires 201 are secured to the retainer 27.

As can be seen, the high-voltage electric wires 201 secured to the retainer 27 are also secured, by the retainer 27, to the female inner housing 22 press-fit-coupled with the press-fit coupling portion 276 of the retainer 27 and to the housing shell 23, to which the retainer 27 is secured by the engaging locks 54 being in engagement with the engaging openings 236.

As described above, the harness-side connector 20 includes the high-voltage electric wire 201 having the harness-side terminal 21 attached to the tip thereof; and the female inner housing 22 and the housing shell 23 having the harness-side terminal 21 disposed therein. The harness-side connector 20 includes the retaining portion main body 222 and the shell main body 232 having the harness-side terminal 21 disposed therein, and the harness insertion cylinder 221 and the harness insertion outer cylinder 231 in communication with the retaining portion main body 222 and the shell main body 232, the harness insertion cylinder 221 and the harness insertion outer cylinder 231 having the high-voltage electric wire 201 inserted thereinto. The harness-side connector 20 further includes the retainer 27 outserted over the portion of the high-voltage electric wire 201 that is inserted into the harness insertion outer cylinder 231 and thus retaining the high-voltage electric wire 201. The retainer 27 includes the retainer securing portion 271 inserted into the harness insertion outer cylinder 231 to be secured, and the electric wire retaining portion 272 protruding from the harness insertion outer cylinder 231 and retaining the high-voltage electric wire 201. The electric wire retaining portion 272 has the electric wire insertion hole 273 retaining the high-voltage electric wire 201 inserted therethrough. The electric wire retaining portion 272 includes the securing-side retaining portion 274 integrally formed with the retainer securing portion 271, the securing-side retaining portion 274 defining the securing-side arcked groove 273a, and the attachment retaining portion 275 (retainer cover 60) defining the attachment-side side arcked groove 273b, the attachment retaining portion 275 (retainer cover 60) being attached to the securing-side retaining portion 274. Therefore, even if a vibration acts on the high-voltage electric wire 201, exertion of the influence of the vibration on the harness-side connector 20 is suppressed.

This will be described in more detail. With the above-described configuration, in a state where the retainer 27 is secured to the lower shell 32 by the retainer securing portion 271, the attachment retaining portion 275 is attached to the securing-side retaining portion 274 integrally formed with the retainer securing portion 271. With such a configuration, the electric wire insertion hole 273 is formed, and thus the high-voltage electric wire 201 inserted into the harness insertion outer cylinder 231 is secured. That is, the high-voltage electric wire 201 is secured to the female inner housing 22 and the housing shell 23 via the retainer 27. Even if a vibration acts on the high-voltage electric wire 201, the exertion of the influence of the vibration on the female inner housing 22 and the housing shell 23 is suppressed.

The electric wire retaining portion 272, which secures the high-voltage electric wire 201 by attaching the attachment retaining portion 275 to the securing-side retaining portion 274 integrally formed with the retainer securing portion 271, protrudes from the harness insertion outer cylinder 231. Therefore, the attachment retaining portion 275 is attached to the securing-side retaining portion 274 easily.

After the relative positions of the female inner housing 22, the housing shell 23, the high-voltage electric wire 201 and the retainer 27 are adjusted, the attachment retaining portion 275 is attached to the securing-side retaining portion 274, protruding from the harness insertion outer cylinder 231, to retain the high-voltage electric wire 201. With such a configuration, the high-voltage electric wire 201 is secured to the female inner housing 22 and the housing shell 23 easily and with high precision.

The rib 278 locally pressing the outer surface of the high-voltage electric wire 201 is provided on the inner surface defining the electric wire insertion hole 273, that is, in the securing-side arcked groove 273a and the attachment-side arcked groove 273b. With such a configuration, the attachment retaining portion 275 is attached to the securing-side retaining portion 274, so that the rib 278 locally presses the outer surface of the high-voltage electric wire 201 inserted through the electric wire insertion hole 273. Therefore, the securing force of the electric wire retaining portion 272 of the retainer 27 on the high-voltage electric wire 201 is increased, and thus the high-voltage electric wire 201 is retained with certainty.

The attachment retaining portion 275 and the securing-side retaining portion 274 are formed separately from each other. Therefore, the high-voltage electric wire 201 is easily disposed in the securing-side arcked groove 273a provided in the securing-side retaining portion 274.

The attachment retaining portion 275 is attached to the securing-side retaining portion 274 having the high-voltage electric wire 201 disposed in the securing-side arcked groove 273a, and is put into engagement with the securing-side retaining portion 274 by the engaging securing portion 277. With such a configuration, the high-voltage electric wire 201 inserted through the electric wire insertion hole 273 is retained easily and with certainty.

The wire seal 26 outserted over the portion of the high-voltage electric wire 201 that is inserted into the harness insertion cylinder 221 is provided on the upward side Hu with respect to the retainer 27. Therefore, the space between the harness insertion cylinder 221 and the high-voltage electric wire 201 is sealed on the upward side Hu with respect to the retainer 27. In addition, the wire seal 26 is disposed on the upward side Hu with respect to the retainer 27, and therefore, the wire seal 26 is prevented by the retainer 27 from being pulled off inadvertently.

Two high-voltage electric wires 201 are provided, and two electric wire insertion holes 273 are provided in correspondence with the number of the high-voltage electric wires 201. Therefore, the high-voltage electric wires 201 is inserted into the two electric wire insertion holes 273 respectively, and is secured with certainty.

The engaging lock 54 engaged with, and securing, the retainer securing portion 271 inserted into the harness insertion outer cylinder 231 is provided. With such a configuration, the engaging lock 54 is put into engagement with the harness insertion outer cylinder 231 to secure the retainer securing portion 271. Therefore, the retainer securing portion 271 is inserted into the harness insertion outer cylinder 231 to engage and secure the engaging lock 54. The ease of assembly is improved over the case where, for example, the retainer securing portion 271 is secured by screwing or the like.

The housing shell 23 and the female inner housing 22 disposed in the housing shell 23 are provided. The housing shell 23 includes the shell main body 232 and the harness insertion outer cylinder 231, and the female inner housing 22 includes the retaining portion main body 222 and the harness insertion cylinder 221. The retainer securing portion 271 is inserted into the harness insertion outer cylinder 231 of the housing shell 23. The retainer securing portion 271 includes the press-fit coupling portion 276 coupled with the harness insertion cylinder 221 of the female inner housing 22.

Therefore, the retaining portion main body 222 of the female inner housing 22 is disposed in the shell main body 232 of the housing shell 23, and the harness insertion cylinder 221 of the female inner housing 22 is disposed in the harness insertion outer cylinder 231 of the housing shell 23. The high-voltage electric wire 201 is inserted from the harness insertion cylinder 221 of the female inner housing 22, and the harness-side terminal 21 provided at the tip of the high-voltage electric wire 201 is disposed in the retaining portion main body 222 of the female inner housing 22.

The retainer 27 is secured to the housing shell 23 by the retainer securing portion 271 inserted into the harness insertion outer cylinder 231 of the hosing shell 23, and the harness insertion cylinder 221 of the female inner housing 22 is coupled with the press-fit coupling portion 276 of the retainer 27 secured to the housing shell 23, so that the female inner housing 22 is secured to the housing shell 23 via the retainer 27. In this manner, the housing shell 23 and the female inner housing 22 secured to each other via the retainer 27 form a double-wall housing.

The retainer securing portion 271 is secured to the harness insertion outer cylinder 231 of the housing shell 23. Therefore, the female inner housing 22 is firmly secured via the retainer 27 including the retainer securing portion 271 secured to the harness insertion outer cylinder 231 of the housing shell 23.

The press-fit coupling portion 276 allows the bottom portion of the harness insertion cylinder 221 of the female inner housing 22 to be press-fitted thereinto. Therefore, the female inner housing 22 is firmly coupled with the retainer 27.

The crushing rib 53 protruding in a direction crossing the press-fit direction (height direction H) is provided in the inner cylinder 52 included in the press-fit coupling portion 276. With such a configuration, the female inner housing 22 is press-fitted into the press-fit coupling portion 276, so that the crushing rib is deformed. Therefore, the female inner housing 22 is coupled with the retainer 27 more firmly.

The shell seal 28 is provided in the harness insertion cylinder 221 of the female inner housing 22. With such a configuration, the space between the harness insertion cylinder 221 of the female inner housing 22 and the harness insertion outer cylinder 231 of the housing shell 23 is sealed. Therefore, foreign objects are prevented from entering the harness-side connector 20 through a path between the harness insertion cylinder 221 of the female inner housing 22 and the harness insertion outer cylinder 231 of the housing shell 23.

The retainer securing portion 271 of the retainer 27 is disposed in the harness insertion outer cylinder 231 of the housing shell 23. Therefore, the shell seal 28 is prevented from being pulled off inadvertently.

The harness-side terminal according to the present disclosure corresponds to the harness-side terminal 21 in the above-described embodiment, and in a similar manner,
the electric wire corresponds to the high-voltage electric wire 201,
the housing corresponds to the female inner housing 22 and the housing shell 23,
the connector corresponds to the harness-side connector 20,
the main body corresponds to the retaining portion main body 222 and the shell main body 232,
the electric wire insertion portion corresponds to the harness insertion cylinder 221 and the harness insertion outer cylinder 231,
the retainer corresponds to the retainer 27,
the retainer securing portion corresponds to the retainer securing portion 271,
the electric wire retaining portion corresponds to the electric wire retaining portion 272,
the electric wire insertion hole corresponds to the electric wire insertion hole 273,
the securing-side retaining portion corresponds to the securing-side retaining portion 274,
the attachment retaining portion corresponds to the attachment retaining portion 275 (retainer cover 60),
the pressing portion corresponds to the rib 278,
the engaging portion corresponds to the engaging securing portions 277,
the electric wire seal corresponds to the wire seal 26,
the retainer engaging portion corresponds to the engaging lock 54,
the outer shell corresponds to the housing shell 23,
the inner housing corresponds to the female inner housing 22,
the coupling portion corresponds to the press-fit coupling portion 276,
the crushing protrusion corresponds to the crushing rib 53, and
the housing seal corresponds to the shell seal 28.
   However, the present disclosure is not limited to the above-described embodiment, and may be applied based on the technological idea defined by the claims and may be carried out in many embodiments.

For example, in the above-described embodiment, the generally semi-circular securing-side arcked grooves 273a are provided in the securing-side retaining portion 274, and the generally semi-circular attachment-side arcked grooves 273b are provided in the attachment retaining portion 275. The securing-side retaining portion 274 and the attachment retaining portion 275 are assembled together to form the generally circular electric wire insertion holes 273. Alternatively, generally U-shaped securing-side arcked grooves 273a as seen in the height direction H may be provided in the securing-side retaining portion 274, and the openings of the generally U-shaped securing-side arcked grooves 273a may be closed by the attachment retaining portion 275.

The wire seal 26 outserted over the high-voltage electric wires 201 and disposed in the harness insertion cylinder 221 may be pressed by the retainer securing portion 271 of the retainer 27 disposed in the harness insertion outer cylinder 231. In this manner, a pre-stress may act on the wire seal 26, and the sealing capability of the wire seal 26 may be improved.

The retainer 27 has two electric wire insertion holes 273 in correspondence with the number (two) of the high-voltage electric wires 201. Alternatively, for example, the two electric wire insertion holes 273 may be disposed to be away from each other by a predetermined interval in the width direction W, and may be in communication with each other via a slit extending in the width direction W. The wire harness 200 may include one high-voltage electric wire 201, or three or more high-voltage electric wires 201.

The electric wire retaining portion 272 in the retainer 27 includes the securing-side retaining portion 274 and the attachment retaining portion 275, which are formed separately from each other. Alternatively, the two securing-side arcked grooves 273a of the securing-side retaining portion 274 may be respectively assembled with different attachment retaining portions 275 each including the attachment-side arcked groove 273b. The attachment retaining portion 275 and the securing-side retaining portion 274 may be coupled with each other via a hinge to be integral with each other.

The ribs 278 extending in the height direction H are provided on the inner surface of each of the electric wire insertion holes 273. Instead of the ribs 278, other protrusions such as semispherical protrusions or the like may be provided, or the inner surface of each of the electric wire insertion holes 273 may be convexed and concaved.

The crushing ribs 53 are provided on the inner cylinder 52 included in the press-fit coupling portion 276. Alternatively, the crushing ribs 53 may be provided on a portion of the harness insertion cylinder 221 that is to be press-fitted into the press-fit coupling portion 276. The crushing ribs 53 may be provided both on the portion of the harness insertion cylinder 221 that is to be press-fitted into the press-fit coupling portion 276 and on the inner cylinder 52. In the case where the crushing ribs 53 are provided on both of these, the crushing ribs 53 may be disposed to be shifted from each other.

In the above description, the housing shell 23, in which the resin female inner housing 22 is to be disposed, is formed of a metal material in order to provide the shielding function. Alternatively, the female inner housing 22 to be disposed in the housing shell 23 may be formed of a metal material, and the housing shell 23 may be formed of a resin.

In the above description, the bottom portion of the harness insertion cylinder 221 of the female inner housing 22 is press-fitted into the press-fit coupling portion 276 of the retainer 27 to couple the female inner housing 22 and the retainer 27 to each other. The retainer 27 and the harness insertion cylinder 221 may be coupled with each other by any other method than press-fitting.

In the above description, the housing shell 23 is formed by assembling the upper shell 31 and the lower shell 32 by the joining portion 33. The housing shell 23 may be of an integral type. Whether the housing shell 23 is of a divided type or an integral type, the position of the division in the case where the housing shell 23 is of a divided type, and the like may be appropriately selected in accordance with the designed shape and reasons regarding the assembly.

### REFERENCE SIGNS LIST

20 . . . . Harness-side connector
21 . . . . Harness-side terminal
22 . . . . Female inner housing
23 . . . . Housing shell
26 . . . . Wire seal
27 . . . . Retainer
28 . . . . Shell seal
32 . . . . Lower shell
53 . . . . Crushing rib
54 . . . . Engaging lock
60 . . . . Retainer cover
201 . . . . High-voltage electric wire
221 . . . . Harness insertion cylinder
222 . . . . Retaining portion main body
231 . . . . Harness insertion outer cylinder
232 . . . . Shell main body
271 . . . . Retainer securing portion
272 . . . . Electric wire retaining portion
273 . . . . Electric wire insertion hole
274 . . . . Securing-side retaining portion
275 . . . . Attachment retaining portion
278 . . . . Rib
276 . . . . Press-fit coupling portion
277 . . . . Engaging securing portion

1. A connector, comprising:
an electric wire having a harness-side terminal attached to a tip thereof; and
a housing having the harness-side terminal disposed therein,
wherein:
the housing includes:
a main body having the harness-side terminal disposed therein, and
an electric wire insertion portion in communication with the main body, the electric wire insertion portion having the electric wire inserted thereinto,
the connector further includes a retainer outserted over a portion of the electric wire that is inserted into the electric wire insertion portion and thus retaining the electric wire,
the retainer includes:
a retainer securing portion inserted into the electric wire insertion portion to be secured, and
an electric wire retaining portion protruding from the electric wire insertion portion and retaining the electric wire, and
the electric wire retaining portion has an electric wire insertion hole retaining the electric wire inserted therethrough, and includes:
a securing-side retaining portion integrally formed with the retainer securing portion, the securing-side retaining portion defining a part of the electric wire insertion hole, and
an attachment retaining portion defining another part of the electric wire insertion hole, the attachment retaining portion being attached to the securing-side retaining portion.

2. The connector according to claim 1, further comprising a pressing portion provided on an inner surface defining the electric wire insertion hole, the pressing portion locally pressing an outer surface of the electric wire.

3. The connector according to claim 1, wherein:
the attachment retaining portion and the securing-side retaining portion are formed separately from each other, and
the connector includes an engaging portion putting the attachment retaining portion and the securing-side retaining portion, which are formed separately from each other, into engagement with each other to assemble and secure the attachment retaining portion and the securing-side retaining portion to each other.

4. The connector according to claim 2, wherein:
the attachment retaining portion and the securing-side retaining portion are formed separately from each other, and
the connector includes an engaging portion putting the attachment retaining portion and the securing-side retaining portion, which are formed separately from each other, into engagement with each other to assemble and secure the attachment retaining portion and the securing-side retaining portion to each other.

5. The connector according to claim 1, further comprising an electric wire seal outserted over the portion of the electric wire that is inserted into the electric wire insertion portion, the electric wire seal being provided on the tip side with respect to the retainer to seal a space between the electric wire insertion portion and the electric wire.

6. The connector according to claim 1, wherein a plurality of the electric wires are provided, and a plurality of the electric wire insertion portions are provided in correspondence with the number of the electric wires.

7. The connector according to claim 1, further comprising a retainer engaging portion engaged with, and securing, the retainer securing portion inserted into the electric wire insertion portion.

8. The connector according to claim 1, wherein:
the housing includes:
an outer shell, and
an inner housing disposed in the outer shell,
the outer shell and the inner housing each include the main body and the electric wire insertion portion,
the retainer securing portion is inserted into the electric wire insertion portion of the outer shell, and
the retainer securing portion includes a coupling portion coupled with the electric wire insertion portion of the inner housing.

9. The connector according to claim 8, wherein the retainer securing portion is secured to the electric wire insertion portion of the outer shell.

10. The connector according to claim 8, wherein the coupling portion allows the electric wire insertion portion of the inner housing to be press-fitted thereinto.

11. The connector according to claim 9, wherein the coupling portion allows the electric wire insertion portion of the inner housing to be press-fitted thereinto.

12. The connector according to claim 10, wherein at least one of the coupling portion and a portion of the inner housing that is press-fitted into the coupling portion has a crushing protrusion provided thereon, the crushing protrusion protruding in a direction crossing a press-fit direction in which the electric wire insertion portion of the inner housing is press-fitted into the coupling portion.

13. The connector according to claim 11, wherein at least one of the coupling portion and a portion of the inner housing that is press-fitted into the coupling portion has a crushing protrusion provided thereon, the crushing protrusion protruding in a direction crossing a press-fit direction in which the electric wire insertion portion of the inner housing is press-fitted into the coupling portion.

14. The connector according to claim 8, further comprising a housing seal sealing a space between the electric wire insertion portion of the inner housing and the electric wire insertion portion of the outer shell.

15. A retainer included in a connector including an electric wire having a harness-side terminal attached to a tip thereof, and a housing having the harness-side terminal disposed therein, the housing including a main body having the harness-side terminal disposed therein and an electric wire insertion portion in communication with the main body, the electric wire insertion portion having the electric wire inserted thereinto,
the retainer comprising:
a retainer securing portion inserted into the electric wire insertion portion to be secured, and
an electric wire retaining portion protruding from the electric wire insertion portion and retaining the electric wire,
wherein:
the electric wire retaining portion has an electric wire insertion hole retaining the electric wire inserted therethrough, and includes:
a securing-side retaining portion integrally formed with the retainer securing portion, the securing-side retaining portion defining a part of the electric wire insertion hole, and
an attachment retaining portion defining another part of the electric wire insertion hole, the attachment retaining portion being attached to the securing-side retaining portion, and
the retainer is outserted over, and secures, the electric wire inserted into the electric wire insertion portion.
